(19) United States
(12) Patent Application Publication
(10) Pub. No.: US 2019/0101186 A1
(43) Pub. Date: Apr. 4, 2019

(54) DRIVING BELT AND MANUFACTURING METHOD THEREOF

(71) Applicant: TOYOTA JIDOSHA KABUSHIKI KAISHA, Toyota-shi (JP)

(72) Inventor: Keisuke NINOMIYA, Susono-shi (JP)

(73) Assignee: TOYOTA JIDOSHA KABUSHIKI KAISHA, Toyota-shi (JP)

(21) Appl. No.: 16/148,346

(22) Filed: Oct. 1, 2018

(30) Foreign Application Priority Data
Sep. 29, 2017 (JP) 2017-190690

(51) Int. Cl. F16G 5/16

(52) U.S. Cl. CPC F16G 5/16

(57) ABSTRACT

A driving belt in which elements may be engaged easily with a hoop, and a manufacturing method thereof. Element includes a first element as a standard element and a second element to be inserted between the adjacent first elements in a final phase of assemble. The second element includes a second saddle surface, and pillars erected on each width end of the second saddle surface. An opening width between the pillars is wider than the width of the hoop. The second element is provided with at least one of a second boss fitted into the first dimple of the first element, and a second dimple fitted onto the first boss of the first element.

### CROSS REFERENCE TO RELATED APPLICATIONS

The present disclosure claims the benefit of Japanese Patent Application No. 2017-190690 filed on Sep. 29, 2017 with the Japanese Patent Office, the disclosure of which is incorporated herein by reference in its entirety.

### BACKGROUND

### Field of the Disclosure

Embodiments of the present disclosure relate to the art of a driving belt used in a transmission device such as a continuously variable transmission (referred to as CVT hereinafter), and a method for manufacturing the belt.

### Discussion of the Related Art

JP-T-2017-516966 describes one example of a driving belt such as a push belt. The belt taught by JP-T-2017-516966 is configured by arranging several hundreds of metal elements (or blocks) with their postures aligned and binding the elements in loop form by the hoop (or carrier or ring). The belt thus formed is applied to a pair of pulleys in which running diameters of the belt in the pulleys may be changed arbitrarily. Each of the pulleys includes a pair of sheaves, and the belt is held between conical surfaces of the sheaves opposed to each other. The elements of the belt are clamped by the sheaves to frictionally transmit torque with a desired torque transmitting capacity. In this situation, the elements are pushed radially outwardly by the sheaves but fastened by the hoop to maintain the desired running diameters. Since the elements are clamped by the shaves tightly, the elements have to be pulled out of the pulley by the belt. Thus, in order to keep the elements in the loop form, each of the elements is engaged respectively with a radially outer surface of the hoop, and in order to pull the elements out of the pulley, each of the elements is engaged respectively with a radially inner surface of the hoop.

According to the teachings of JP-T-2017-516966, specifically, two kinds of the elements are fastened by the hoop (i.e., an endless carrier). Each of the elements respectively comprises: a saddle surface on which the hoop is mounted; a pair of pillars erected on width ends of the saddle surface; and a hook section protruding from one of the pillars toward a width center of the saddle face. Specifically, in a first element, the hook section protrudes from the right pillar. On the other hand, in a second element, the hook section protrudes from the left pillar. The first elements and the second elements are juxtaposed alternately and fastened by the hoop. The elements are interlinked to one another by fitting pins of the element into holes of the adjoining element.

In the belt described in JP-T-2017-516966, one of lateral ends of the hoop is held between the hook section and the saddle surface, and the other lateral end of the hoop is held in a recess formed at a corner between the pillar and the saddle surface. That is, a clearance between the hook section and the pillar opposed thereto is narrower than a width of the hoop. According to the teachings of JP-T-2017-516966, therefore, the hoop is engaged with the element by inserting one of the lateral ends of the hoop between the hook section and the saddle surface while inclining the element with respect to the hoop, and thereafter inserting the other lateral end of the hoop into the above-mentioned recess while turning the element to situate the saddle surface parallel to the hoop.

That is, according to the teachings of JP-T-2017-516966, the element is slightly rotated or twisted to limit damages of the hoop and the element resulting from the assembling work. However, there is almost no clearance between the adjacent elements in the final phase of the assembling work in which the pins of each of the elements are individually fitted into the holes of the adjacent elements. Therefore, the last piece of the element may interfere with the pin protruding from the element when fitted into the narrow clearance between the elements. Thus, it may be difficult to engage the last piece of the element with the hoop without damaging the elements and the hoop.

Aspects of embodiments of the present disclosure have been conceived noting the foregoing technical problems, and it is therefore an object of the present disclosure to provide a driving belt in which elements may be engaged easily with a hoop, and a manufacturing method thereof.

### SUMMARY

According to at least one aspect of the present disclosure, there is provided a driving belt comprising: a plurality of first elements juxtaposed in a same orientation; and a hoop fastening the first elements in loop form. The first element includes: a first saddle surface to which an inner peripheral surface of the hoop is contacted; a pair of hook sections erected on each end section of the first saddle surface while protruding respectively toward a width center of the first element to cover end sections in a width direction of the hoop; a first boss projecting from a front surface of the first element; and a first dimple recessing to the inside from a rear surface of the first element. The first boss and the first dimple fit together to form an array of the first elements, and an opening width between the hook sections is narrower than a width of the hoop. In order to achieve the above-explained objective, the driving belt is provided with a second element that is inserted between the adjacent first elements. The second element includes: a second saddle surface to which an inner peripheral surface of the hoop is contacted; a pair of pillars erected on each end section of the second saddle surface in such a manner that an opening width between the pillars is wider than the width of the hoop; and at least one of a second boss fitted into the first dimple of the first element, and a second dimple fitted onto the first boss of the first element.

In a non-limiting embodiment, the second element may further include a stopper attached respectively to the pillars to be opposed to an radially outer side edge of the hoop. An opening width between the pillars may be narrower than the width of the hoop.

In a non-limiting embodiment, the stopper may include a stopper surface opposed to the radially outer side edge of the hoop. The stopper surface may be inclined such that a clearance between the stopper surface and the second saddle surface is wider than a thickness of the hoop at an innermost portion of the stopper surface in the width direction, but narrower than the thickness of the hoop at a portion outside of the radially outer side edge of the hoop in the width direction.

According to another aspect of the present disclosure, there is provided a manufacturing method of the above-mentioned driving belt, comprising: fitting a predetermined number of the first elements that is at least one piece shorter than a total required number of the elements with the hoop by letting through the hoop between the hook sections; fitting the first boss of the first element into the first dimple of the adjacent first element; inserting a second element between the adjacent first elements already fitted with the hoop from an inner circumferential side of the hoop; disposing the hoop on a second saddle surface of the second element by letting the hoop through an opening between a pair of pillars erected on each end section of the second saddle surface; and thereafter fitting a second boss of the second element into the first dimple of the adjacent first element, and fitting a second dimple of the second element onto the first boss of another adjacent first element.

In a non-limiting embodiment, the manufacturing method may further comprise attaching a stopper respectively to the pillars after inserting the second element between the adjacent first elements already fitted with the hoop thereby reducing an opening width between the stoppers is narrower than the width of the hoop.

Thus, the driving belt according to the embodiment of the present disclosure comprises the first element engaged with the hoop and the second element inserted between the first elements. Although the second element is provided with the boss and the dimple, the clearance between the pillars of the second element is wider than the width of the hoop. According to the embodiment of the present disclosure, therefore, the second element as a last piece to be fitted with the hoop may be inserted easily between the adjacent first elements already fitted with the hoop by merely widening a clearance between the adjacent first elements to an extent that the boss can pass therethrough, without inclining the second element with respect to the hoop. For this reason, the driving belt may be assembled easily without interference between the second element and the hoop, and without damaging the elements and the hoop. After inserting the second element between the adjacent first elements already fitted with the hoop, the boss and the dimple of the second element are fitted together with the bosses and the dimples of the adjacent first elements to maintain an array of the elements.

In a case of using the second element provided with the pair of pillars, the hoop may be prevented from passing though the clearance between the pillars. In this case, therefore, the second element may be pulled out of a pulley certainly by the hoop during operation. In addition, disengagement of the second element from the hoop may be prevented certainly even if a clearance between the elements is increased for some reason.

As described, the stopper includes the stopper surfaces, and the clearance between the stopper surface and the second saddle surface is wider than a thickness of the hoop at an innermost portion of the stopper surface in the width direction, but narrower than the thickness of the hoop at a portion outside of the radially outer side edge of the hoop in the width direction. Therefore, a relative movement of the hoop in the width direction may also be restricted by the stopper surfaces.

In addition, according to the manufacturing method of the present disclosure, the last piece of the element may be fitted easily with the hoop. For this reason, the driving belt may be assembled easily by the manufacturing method of the present disclosure.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1A is a top view and FIG. 1B is a cross-sectional side view showing a pair of pulleys and a driving belt wound around the pulleys;

FIG. 2 is a perspective view showing a structure of a hoop;

FIG. 3 is a front view showing a configuration of a first element;

FIG. 4 is a cross-sectional view showing a cross section of the driving belt in which an array of the standard elements is engaged with the hoop;

FIG. 5 is a schematic illustration showing a procedure of engaging the first element with the hoop;

FIG. 6 is a front view showing one example of a configuration of a second element;

FIG. 7 is a schematic illustration showing a procedure of inserting the second element between the first elements to engage the second element with the hoop;

FIG. 8 is a front view showing the second element provided with a stopper; and

FIG. 9 is a front view showing the second element provided with a projection serving as the stopper.

### DETAILED DESCRIPTION OF THE PREFERRED EMBODIMENT(S)

Embodiments of the present disclosure will now be explained with reference to the accompanying drawings. Note that the embodiments shown below are merely examples of cases where the present disclosure has been actualized, and do not limit the present disclosure.

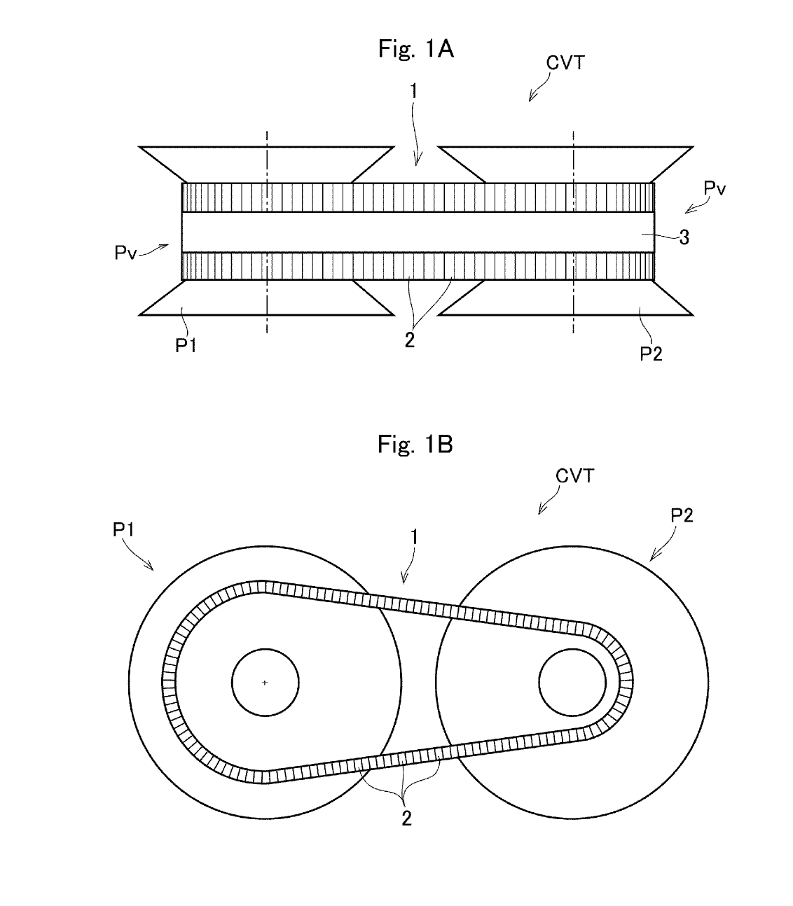

A driving belt 1 according to the embodiment of the present disclosure is employed as a V belt of a belt-driven continuously variable transmission (to be abbreviated as the “CVT” hereinafter) installed in a vehicle to transmit power between two pulleys. Specifically, as shown in FIGS. 1A and 1B, the driving belt 1 is wound on respective pulley grooves Pv of a drive pulley P1 and a driven pulley P2 of the CVT. The driving belt 1 is a so-called a “push belt” in which a plurality of thin metal elements 2 are juxtaposed in a same orientation, and the elements 2 are fastened in loop form by a hoop 3. In the CVT, the elements 2 sequentially enter into the pulley grooves Pv of the drive pulley P1 and the driven pulley P2 with a rotation of the drive pulley P1. In this situation, the elements 2 pulled out of the pulley groove Pv of the drive pulley P1 push the preceding elements so that the driven pulley P2 is rotated frictionally by the elements 2 being pushed in the pulley groove Pv.

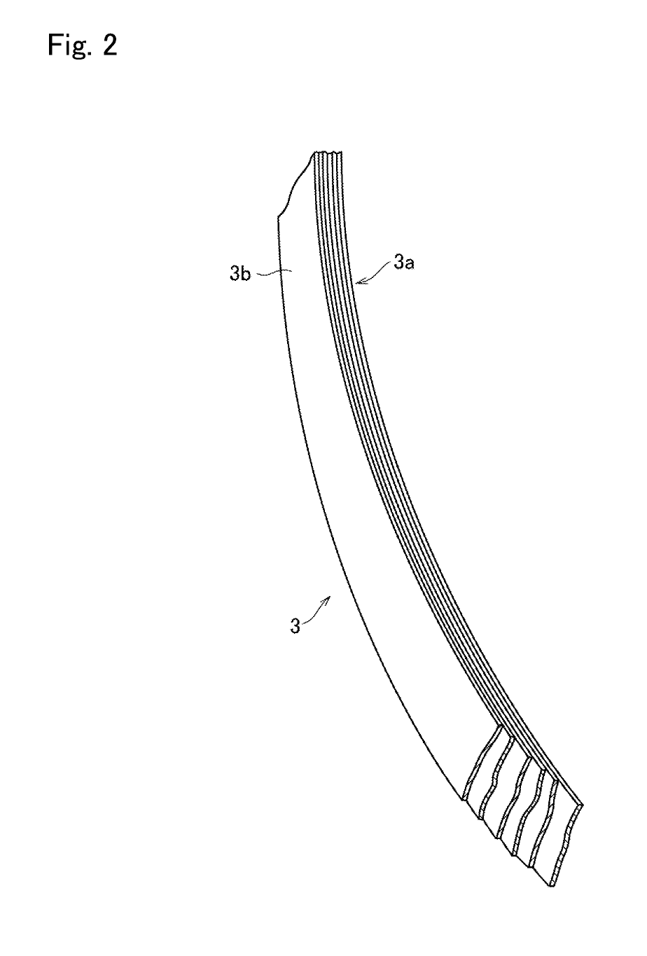

The hoop 3 is an endless metal band that is also called a carrier and a ring. As illustrated in FIG. 2, the hoop 3 is formed of a plurality of layers of a flexible metal band such as a steel band.

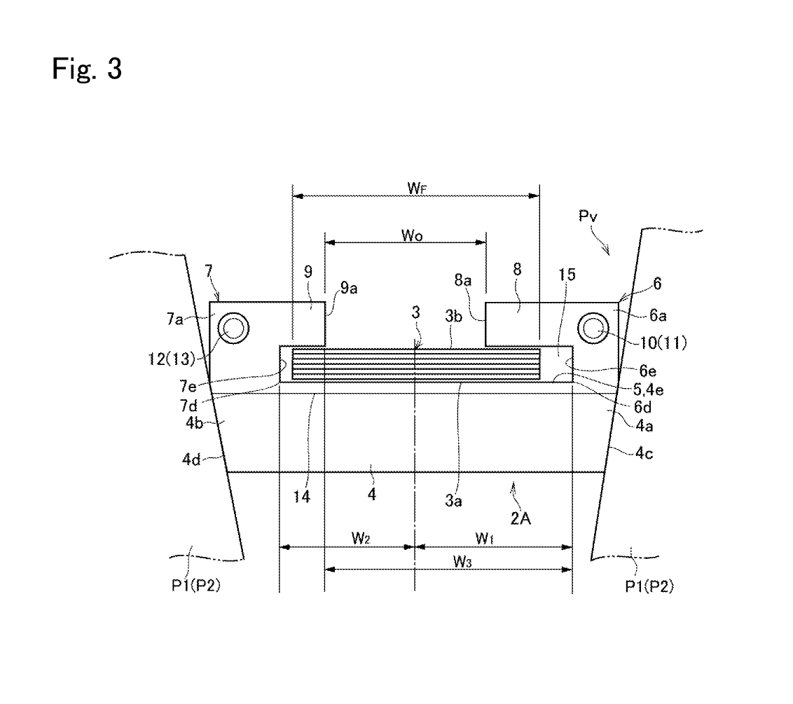

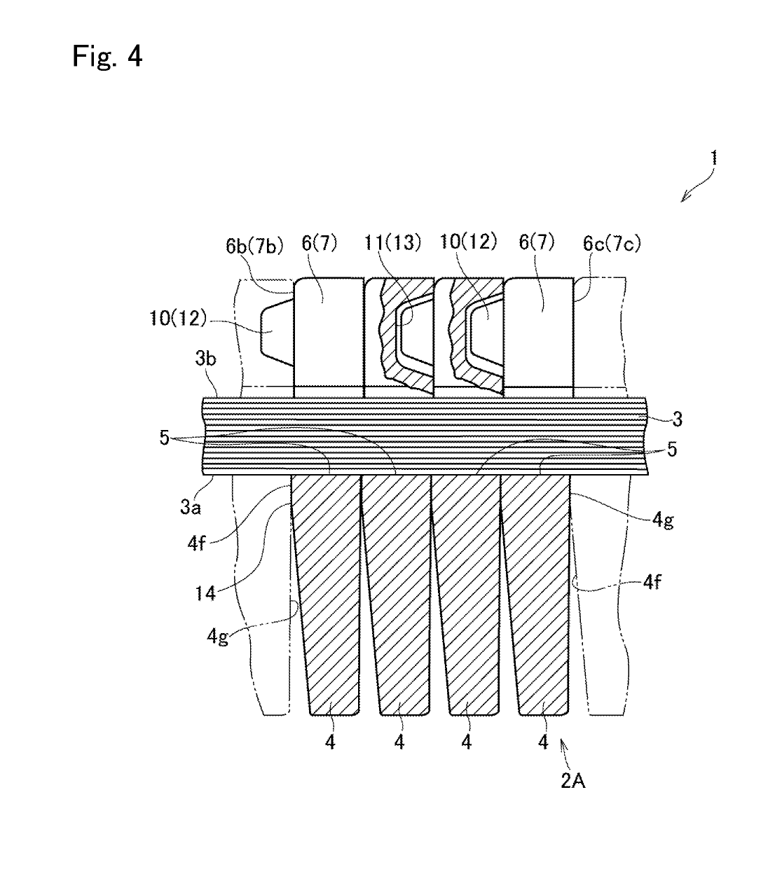

The element 2 includes a plurality (e.g., several hundred) of first elements 2A as standard elements, and at least one second element 2B having a different configuration. Both of the first element 2A and the second element 2B are thin metal plate members, and the first element 2A is provided with a hook section for preventing disengagement from the hoop 3. Specifically, as illustrated in FIGS. 3 and 4, the first element 2A comprises a base section 4, a saddle surface 5, a first pillar section 6, a second pillar section 7, a first hook section 8, a second hook section 9, a first boss 10, a first dimple 11, a second boss 12, and a second dimple 13. Accordingly, the saddle surface 5 serves as a first saddle surface of the embodiment. In addition, the first and second bosses 10, 12 serve as a first boss of the embodiment, and the first and second dimples 11, 13 serve as a first dimple of the embodiment.

The base section 4 is a main body portion of the first element 2A. One end section of the base section 4 in a width direction (a left-right direction of FIG. 3) of the first element 2A configures a first end section 4a, and the other end section of the base section 4 in the width direction of the first element 2A configures a second end section 4b. In the example shown in FIG. 3, the end section on a right side of the base section 4 configures the first end section 4a, and the end section on a left side of the base section 4 configures the second end section 4b. An end surface 4c of the first end section 4a and an end surface 4d of the second end section 4b are each formed as inclined surfaces that are inclined parallel to conical surfaces of the pulley groove Pv. These left and right end surfaces 4c, 4d are so-called flank surfaces of the first element 2A contacted with the pulley groove Pv to frictionally transmit a torque between the drive pulley P1 and the driven pulley P2 through the driving belt 1.

The saddle surface 5 is formed in an end surface 4e on an upper end side of the base section 4 (an up-down direction of FIGS. 2 and 3) of the first element 2A, and is brought into contact to an inner peripheral surface 3a of the hoop 3 to assemble the driving belt 1. Specifically, the saddle surface 5 is formed in the end surface 4e between the first pillar section 6 and the second pillar section 7 respectively formed in both end sections 4a, 4b of the base section 4, as will be mentioned later.

The first pillar section 6 is erected on the saddle surface 5 in the first end section 4a of the base section 4. In the example shown in FIG. 3, the first pillar section 6 extends out upwardly in the height direction of the base section 4, from the first end section 4a on the right side in the width direction of the base section 4. For example, the first pillar section 6 may be formed integrally with the base section 4 by punching the first element 2A out of a metal plate material.

The second pillar section 7 is erected on the saddle surface 5 in the second end section 4b of the base section 4. In the example shown in FIG. 3, the second pillar section 7 extends out upwardly in the height direction of the base section 4, from the second end section 4b on the left side in the width direction of the base section 4. The second pillar section 7 is also formed integrally with the base section 4.

The first hook section 8 is formed so as to protrude out from the first pillar section 6 toward the width center of the first element 2A to cover one end section in the width direction of the hoop 3. Specifically, the first hook section 8 projects toward the width center of the first element 2A from an upper end section 6a of the first pillar section 6 in the height direction of the base section 4. The first hook section 8 is formed integrally with the first pillar section 6 and the base section 4.

The second hook section 9 is formed so as to protrude out from the second pillar section 7 toward the width center of the first element 2A to cover other end section in the width direction of the hoop 3. Specifically, the second hook section 9 projects toward the width center of the first element 2A from an upper end section 7a of the second pillar section 7 in the height direction of the base section 4. The second hook section 9 is formed integrally with the second pillar section 7 and the base section 4.

The first boss 10 is formed in the upper end section 6a of the first pillar section 6. Specifically, the first boss 10 projects to the outside from a front surface 6b of the first pillar section 6 in a plate thickness direction of the upper end section 6a. As shown in FIG. 4, the first boss 10 is formed so as to loosely fit together with the first dimple 11 of an adjacent other element 2 to form an element array.

The first dimple 11 is formed in the upper end section 6a of the first pillar section 6. Specifically, the first dimple 11 recesses to the inside from a rear surface 6c of the first pillar section 6 in the plate thickness direction of the upper end section 6a. As shown in FIG. 4, the first dimple 11 is formed so as to loosely fit together with the first boss 10 of an adjacent other element 2 to form the element array. Thus, in the driving belt 1, the first boss 10 and the first dimple 11 fit together in the fellow elements 2 adjacent in the peripheral direction of the hoop 3.

Similarly, the second boss 12 is formed in the upper end section 7a of the second pillar section 7. Specifically, the second boss 12 projects to the outside from a front surface 7b of the second pillar section 7 in the plate thickness direction of the upper end section 7a. As shown in FIG. 4, the second boss 12 is formed so as to loosely fit together with the second dimple 13 of an adjacent other element 2 to form the element array.

The second dimple 13 is formed in the upper end section 7a of the second pillar section 7. Specifically, the second dimple 13 recesses to the inside from a rear surface 7c of the second pillar section 7 in the plate thickness direction of the upper end section 7a. As shown in FIG. 4, the second dimple 13 is formed so as to loosely fit together with the second boss 12 of an adjacent other element 2A to form the element array. Thus, in the driving belt 1, the second boss 12 and the second dimple 13 fit together in the fellow elements 2 adjacent in the peripheral direction of the hoop 3.

By the first boss 10 and first dimple 11, and the second boss 12 and second dimple 13 respectively fitting together as described above, fellow adjacent elements 2 are positioned, and relative movement of those fellow adjacent elements 2 is restricted to maintain the loop form of the element array.

The array of the first elements 2A is bound by the hoop 3 in a circular manner in the same orientation, and is wound on the drive pulley P1 and the driven pulley P2. In the pulley grooves Pv of the pulleys P1, P2, the first elements 2A are spread like a fan with respect to centers of the pulleys P1, P2 while being contacted closely to one another at a lower side of the base section 4. Therefore, a thickness of a portion on the lower side of the base section 4 the element 2A is reduced gradually. Specifically, a rocking edge 14 is formed at a certain position more to the lower side than the saddle surface 5 in a front surface 4f of the base section 4. The thickness of the base section 4 is thinned from the rocking edge 14 to the lower side than the rocking edge 14. In the pulley grooves Pv of the pulleys P1, P2, therefore, the rocking edge 14 contacts a rear surface 4g of the base section 4 of an adjacent other element 2.

As shown in FIG. 3, in the first element 2A, an opening width W_{O} between a tip section 8a of the first hook section 8 and a tip section 9a of the second hook section 9 is narrower than a width W_{F} of the hoop 3. The tip section 8a and the tip section 9a face each other in the width direction of the first element 2A. By the opening width W_{O} of the first element 2A being narrower than the width W_{F} of the hoop 3 in this way, shedding from the hoop 3 of the first elements 2A is prevented.

In addition, in the first elements 2A, a first width W₁ from the width center of the first element 2A to a base corner 6d of the first pillar section 6 is wider than a second width W₂ from the width center to a base corner 7d of the second pillar section 7, and a third width W₃ from the base corner 6d of the first pillar section 6 to the tip section 9a of the second hook section 9 is wider than the width W_{F} of the hoop 3. The base corner 6d is a portion where an inner wall surface 6e of the first pillar section 6 and the saddle surface 5 intersect, and the base corner 7d is a portion where an inner wall surface 7e of the second pillar section 7 and the saddle surface 5 intersect. The inner wall surface 6e and the inner wall surface 7e face each other in the width direction of the first element 2A. That is, the first width W₁ is a distance between the width center and the base corner 6d, the second width W₂ is a distance between the width center and the base corner 7d, and the third width W₃ is a distance between the base corner 6d and the tip section 9a. On the other hand, the width W_{F} is a distance between both side surfaces in the width direction of the hoop 3.

Thus, in the first element 2A, the first width W₁ is wider than the second width W₂. That is, the first element 2A is configured asymmetrically to left and right in the width direction. Specifically, a space surrounded by the first hook section 8, the first pillar section 6, and the saddle surface 5 is configured wider than a space surrounded by the second hook section 9, the second pillar section 7, and the saddle surface 5. This wide space surrounded by the first hook section 8, the first pillar section 6, and the saddle surface 5 configures a space-for-assembly 15 into which an end section of the hoop 3 is initially inserted when the first element 2A is engaged with the hoop 3.

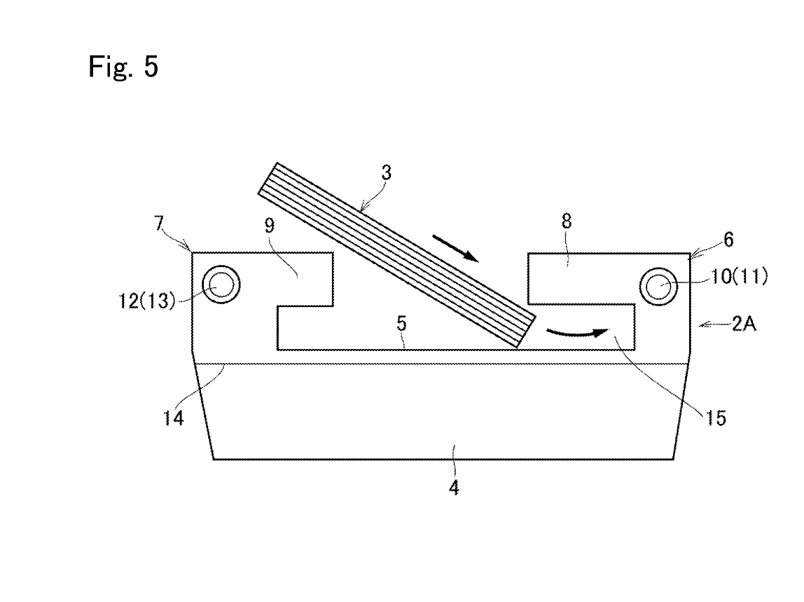

Specifically, as shown in FIG. 5, one end section in the width direction of the hoop 3 is inserted obliquely toward the space-for-assembly 15 of the first element 2A in an initial stage of assembly to engage the first element 2A with the hoop 3. Alternatively, the first element 2A may also be inclined with respect to the hoop 3 to fit the space-for-assembly 15 of the first element 2A to the one end section in the width direction of the hoop 3. In this situation, due to the third width W₃ being wider than the width W_{F} of the hoop 3, the hoop 3 can be easily disposed on the saddle surface 5 of the first element 2A. Thereafter, the first element 2A is moved toward the right side in FIGS. 2 and 5 to a position where the width center of the hoop 3 and the width center of the first element 2A are aligned to each other. Consequently, both of the end sections of the hoop 3 are inserted respectively into the space-for-assembly 15 and the space surrounded by the second hook section 9, the second pillar section 7, and the saddle surface 5. That is, the first element 2A is engaged with the hoop 3. Since the opening width W_{O} of the first element 2A is narrower than the width W_{F} of the hoop 3, disengagement of the first element 2A from the hoop 3 can be prevented after the hoop 3 has been disposed on the saddle surface 5.

Optionally, a crown (not illustrated) projecting upwardly in the height direction at the center may be formed in the saddle surface 5. By providing such a crown or crown-like shape in the saddle surface 5, a position of the hoop 3 in the width direction of the first element 2A can be aligned during running of the driving belt 1. Therefore, the hoop 3 can be disposed in a prescribed position where a center in the width direction of the hoop 3 and the width center of the first element 2A coincide, or a position close to that prescribed position.

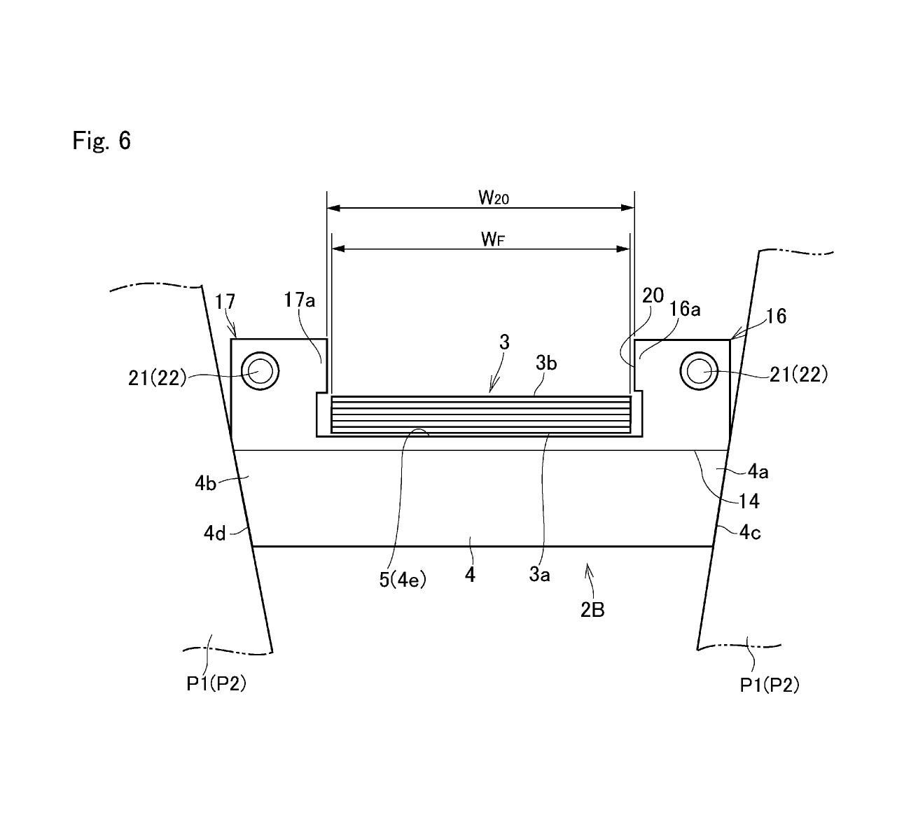

Turning to FIG. 6, there is shown one example of a configuration of the second element 2B having at least one of a boss 21 fitted into the first and second dimples 11, 13 of the first element 2A, and a dimple 22 fitted onto the first and second bosses 10, 12 of the first element 2A. In the second element 2B, an opening width of the second element 2B between the pillars is wider than the width W_{F} of the hoop 3. The remaining configurations of the second element 2B are identical to those of the first element 2A, and hence detailed explanations for the members in common with those of the first element 2A will be omitted by allotting the same reference symbols to the common members.

In the second element 2B, the saddle surface 5 serves as a second saddle surface of the embodiment, and pillars 16 and 17 are erected symmetrically on both sides of the saddle surface 5. In the example shown in FIG. 6, an upper end section of each of the pillars 16 and 17 is individually bent inwardly toward the width center of the saddle surface 5 to form bent sections 16a and 17a. A clearance between the bent sections 16a and 17a serves as an opening 20, and an opening width W₂₀ of the opening 20 is wider than the width W_{F} of the hoop 3.

In the example shown in FIG. 6, the boss 21 and the dimple 22 are formed respectively on each of the pillars 16 and 17 of the second element 2B, at portions corresponding respectively to the first boss 10 and the first dimple 11, and the second boss 12 and the second dimple 13 of the first element 2A. Accordingly, the boss 21 serves as a second boss of the embodiment, and the dimple 22 serves as a second dimple of the embodiment. When the second element 2B is inserted between the first elements 2A, the dimples 22 of the second element 2B are fitted onto the first boss 10 and the second boss 12 of the one of the adjacent first element 2A, and the bosses 21 of the second element 2B are fitted into the first dimple 11 and the second dimple 13 of the other adjacent first element 2A.

According to the embodiment, a total required number of the elements 2 to form the driving belt 1 is determined based on a length of the hoop 3. In order to assemble the driving belt 1, a predetermined number of the first elements 2A that is one or several pieces shorter than the total required number of the elements 2, and one or several piece(s) of the second element(s) 2B to achieve the total required number of the elements 2 are engaged with the hoop 3. A manufacturing method (i.e., an assembling method) of the driving belt 1 will explained hereinafter. First of all, the hoop 3 is held while keeping a predetermined tension, and the first elements 2A is engaged with the hoop 3 by the procedure explained with reference to FIG. 5.

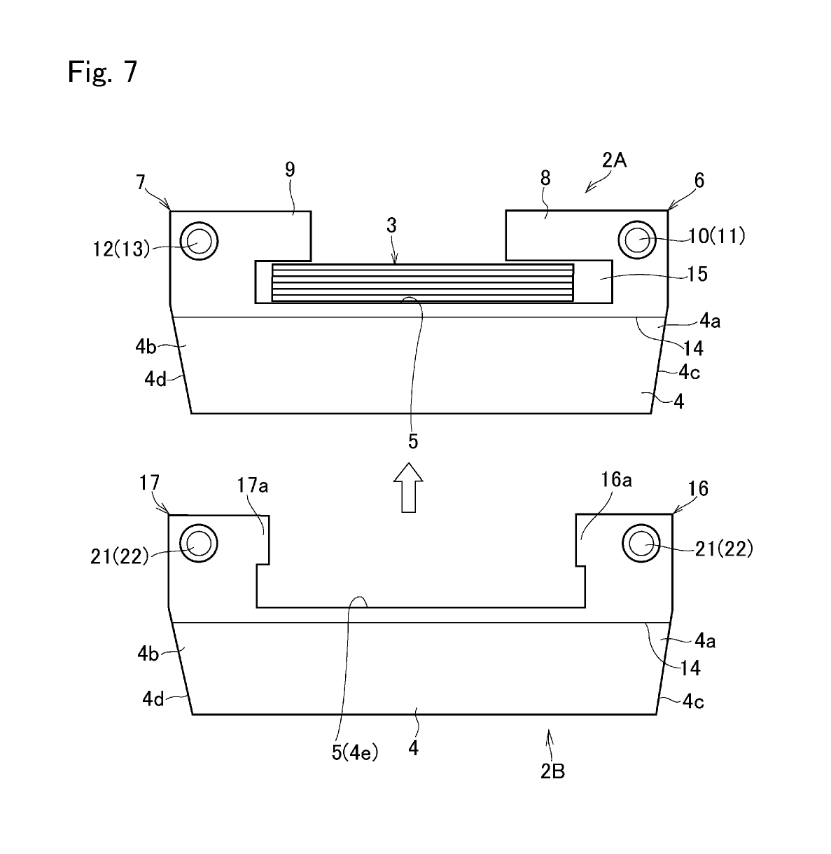

The first elements 2A are fitted with the hoop 3 one by one or by several pieces. After fitting the predetermined number of the first elements 2A with the hoop 3, a clearance is available between the first elements 2A in an amount corresponding to a deficiency number of the first elements 2A with respect to the total required number of the elements 2. Then, as illustrated in FIG. 7, a required number of the second element(s) 2B to achieve the total required number of the elements 2 is/are inserted into the clearance between the first elements 2A to be fitted with the hoop 3 from the inner circumferential side. In this situation, the second element(s) is/are held in such a manner that the opening 20 between the pillars 16 and 17 is aligned with the hoop 3 in the width direction while opening toward the hoop 3. Thereafter, the second element 2B is lifted upwardly toward the hoop 3 while keeping the posture thereof parallel to each of the adjacent first elements 2A. Instead, the second element 2B may also be fitted with the hoop 3 downwardly from above toward the hoop 3 in a reverse situation of FIG. 2.

After the total required number of the elements 2 have been fitted with the hoop 3, the boss and the dimple of the adjacent elements fit together. Consequently, in the final phase of the assembling work, a space (or a clearance) for inserting the last piece of the element 2 between the elements 2 becomes insufficient in accordance with engagement depths of the bosses and the dimples. Therefore, the second element 2B as the last piece is forcedly pushed into the space between the first elements 2A already fitted with the hoop 3. Consequently, the bosses 10, 12 of the first elements 2A are fitted more deeply in the dimples 11, 13 of the adjoining first elements 2A, and the first elements 2A and the hoop 3 are flexibly deformed. As a result, the space for inserting the last piece of the element 2 between the first elements 2A is temporarily widened so that the second element 2B is inserted between the first elements 2A. Instead, the space for inserting the last piece of the element 2 between the first elements 2A may also be widened by applying a load to the adjacent first elements 2A in the length direction of the hoop 3.

Thus, according to the manufacturing method of the embodiment, the second element 2B as the last piece may be inserted easily between the first elements 2A already fitted with the hoop 3 without inclining or twisting the second element 2B, and without interference. According to the manufacturing method of the embodiment, therefore, damages on the second element 2B and the hoop 3 during assembling can be reduced. In other words, the second element 2B may be inserted between the first elements 2A already fitted with the hoop 3 without requiring a fine adjustment. That is, the driving belt 1 may be assembled easily.

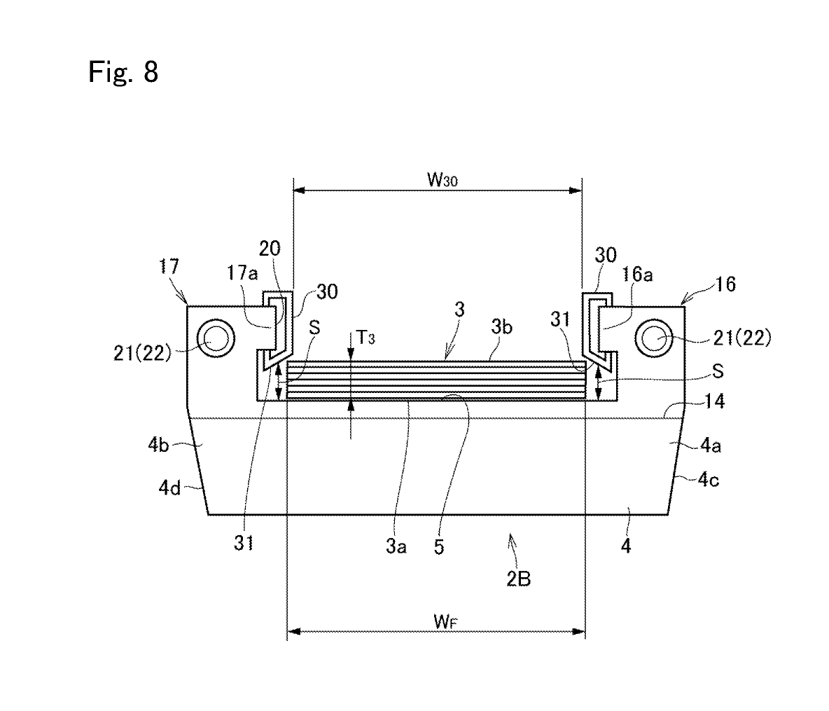

FIG. 8 shows another example of a configuration of the second element 2B. In the second element 2B shown in FIG. 8, a stopper 30 is attached respectively to the bent sections 16a and 17a of the pillars 16 and 17 so as to reduce an opening width W₃₀ of the opening between the pillars 16 and 17 narrower than the width W_{F} of the hoop 3. Specifically, the stopper 30 is a polygonal frame member having an opening made of metal material such as spring steel, and a thickness of the stopper 30 is substantially identical to a thickness of each of the pillars 16 and 17. Each of the bent sections 16a and 17a of the pillars 16 and 17 is individually inserted into the opening of the stopper 30. That is, the stopper 30 is elastically fitted onto each of the bent sections 16a and 17a of the pillars 16 and 17. Optionally, the stopper 30 may also be fixed individually to the bent sections 16a and 17a of the pillars 16 and 17 by welding or the like.

By thus attaching the stopper 30 to each of the bent sections 16a and 17a of the pillars 16 and 17, the opening width W₃₀ between opposed surfaces of the stoppers 30 becomes narrower than the width W_{F} of the hoop 3. In the stopper 30, a stopper surface 31 is formed in a radially inner side of the opposed surface. The stopper surface 31 is inclined to be opposed to a radially outer side edge of the hoop 3 without contacting to the side edge. Specifically, a clearance S between the stopper surface 31 and the saddle surface 5 is wider than a thickness T₃ of the hoop 3 at an innermost portion of the stopper surface 31 in the width direction, but narrower than the thickness T₃ of the hoop 3 at a portion outside of the side edge of the hoop 3 in the width direction. The remaining configurations of the second element 2B shown in FIG. 8 are identical to those of the second element 2B shown in FIG. 6, and hence detailed explanations for the common members will be omitted.

Thus, according to the example shown in FIG. 8, the opening width W₃₀ between the opposed surfaces of the stoppers 30 is narrower than the width W_{F} of the hoop 3. Therefore, disengagement of the second element 2B from the hoop 3 can be prevented by the stoppers 30. In addition, a relative movement of the hoop 3 in the width direction may also be restricted by the stopper surfaces 31. Therefore, disengagement of the second element 2B from the hoop 3 can be prevented more certainly.

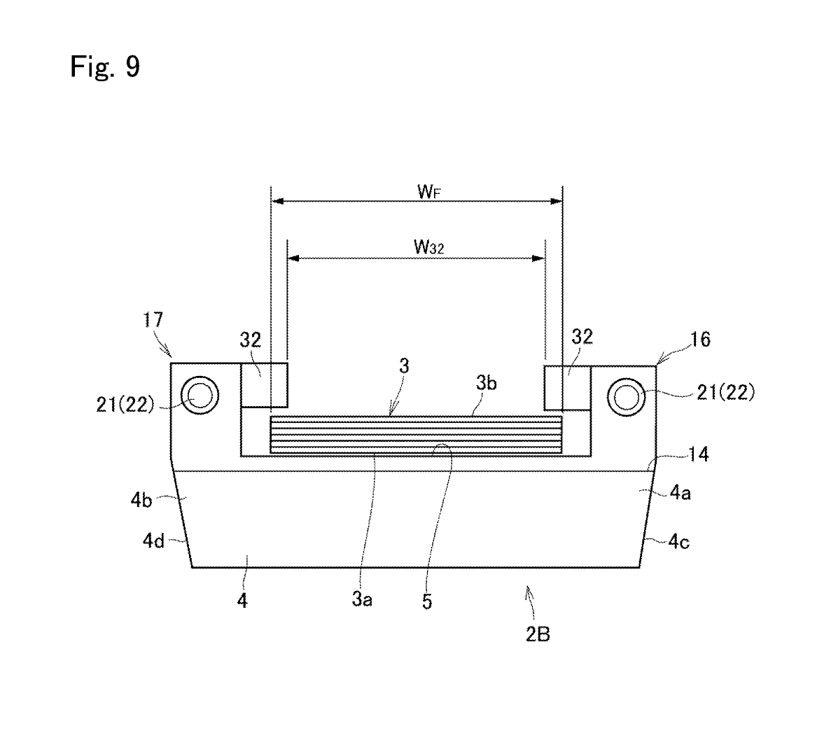

FIG. 9 shows still another example of a configuration of the second element 2B in which the bent sections 16a and 17a of the pillars 16 and 17 are omitted. In the second element 2B shown in FIG. 9, a projection 32 as a stopper is attached respectively to the pillars 16 and 17 by welding or the like in such a manner as to extend to above an outer face 3b of the hoop 3. In other words, the projection 32 serves as the hook section of the first element 2A. The projections 32 are attached to the pillars 16 and 17 after fitting the second element 2B with the hoop 3. The remaining configurations of the second element 2B shown in FIG. 9 are identical to those of the second element 2B shown in FIG. 6, and hence detailed explanations for the common members will be omitted.

According to the example shown in FIG. 9, an opening width W₃₂ between opposed surfaces of the projections 32 is narrower than the width W_{F} of the hoop 3. Therefore, disengagement of the second element 2B from the hoop 3 can be prevented by the projections 32.

Although the above exemplary embodiments of the present disclosure have been described, it will be understood by those skilled in the art that the present disclosure should not be limited to the described exemplary embodiments, and various changes and modifications can be made within the scope of the present disclosure.

For example, the space-for-assembly 15 may be omitted unless the standard element may be engaged with the hoop. In addition, the bosses and the dimples may also be formed on the base section instead of the hook section and the pillar section. Further, number of pairs of the boss and the dimple may be altered arbitrarily. That is, number of pairs of the boss and the dimple may also be not only one pair but also three or more pairs.

What is claimed is:

1. A driving belt, comprising:
a plurality of first elements juxtaposed in a same orientation; and
a hoop fastening the first elements in loop form,
wherein the first element includes
a first saddle surface to which an inner peripheral surface of the hoop is contacted,
a pair of hook sections erected on each end section of the first saddle surface while protruding respectively toward a width center of the first element to cover end sections in a width direction of the hoop,
a first boss projecting from a front surface of the first element, and
a first dimple recessing to the inside from a rear surface of the first element,
the first boss and the first dimple fit together to form an array of the first elements,
an opening width between the hook sections is narrower than a width of the hoop,
the driving belt further comprises a second element that is inserted between the adjacent first elements, and
the second element includes
a second saddle surface to which an inner peripheral surface of the hoop is contacted,
a pair of pillars erected on each end section of the second saddle surface in such a manner that an opening width between the pillars is wider than the width of the hoop, and
at least one of a second boss fitted into the first dimple of the first element, and a second dimple fitted onto the first boss of the first element.

2. The driving belt as claimed in claim 1,
wherein the second element further includes a stopper attached respectively to the pillars to be opposed to an radially outer side edge of the hoop, and
an opening width between the pillars is narrower than the width of the hoop.

3. The driving belt as claimed in claim 2, wherein
the stopper includes a stopper surface opposed to the radially outer side edge of the hoop, and
the stopper surface is inclined such that a clearance between the stopper surface and the second saddle surface is wider than a thickness of the hoop at an innermost portion of the stopper surface in the width direction, but narrower than the thickness of the hoop at a portion outside of the radially outer side edge of the hoop in the width direction.

4. A manufacturing method of a driving belt comprising:
a plurality of first elements juxtaposed in a same orientation; and
a hoop fastening the first elements in loop form,
wherein the first element includes
a first saddle surface to which an inner peripheral surface of the hoop is contacted,
a pair of hook sections erected on each end section of the first saddle surface while protruding respectively toward a width center of the first element to cover end sections in a width direction of the hoop,
a first boss projecting from a front surface of the first element, and
a first dimple recessing to the inside from a rear surface of the first element,
the first boss and the first dimple fit together to form an array of the first elements, and
an opening width between the hook sections is narrower than a width of the hoop,
the manufacturing method comprising:
fitting a predetermined number of the first elements that is at least one piece shorter than a total required number of the elements with the hoop by letting through the hoop between the hook sections;
fitting the first boss of the first element into the first dimple of the adjacent first element;
inserting a second element between the adjacent first elements already fitted with the hoop from an inner circumferential side of the hoop;
disposing the hoop on a second saddle surface of the second element by letting the hoop through an opening between a pair of pillars erected on each end section of the second saddle surface; and
thereafter fitting a second boss of the second element into the first dimple of the adjacent first element, and fitting a second dimple of the second element onto the first boss of another adjacent first element.

5. The manufacturing method of the driving belt as claimed in claim 4, further comprising:
attaching a stopper respectively to the pillars after inserting the second element between the adjacent first elements already fitted with the hoop thereby reducing an opening width between the stoppers is narrower than the width of the hoop.

6. The manufacturing method of the driving belt as claimed in claim 5,
wherein the stopper includes a stopper surface opposed to a radially outer side edge of the hoop, and
the stopper surface is inclined such that a clearance between the stopper surface and the second saddle surface is wider than a thickness of the hoop at an innermost portion of the stopper surface in the width direction, but narrower than the thickness of the hoop at a portion outside of the radially outer side edge of the hoop in the width direction.
